(19) United States
(12) Patent Application Publication
(10) Pub. No.: US 2016/0363240 A1
(43) Pub. Date: Dec. 15, 2016

(54) VACUUM VALVE

(71) Applicant: VAT HOLDING AG, Haag (CH)

(72) Inventors: Cedric WAGNER, Schellenberg (LI); Karlheinz SUMMER, Bludenz (AT); Hanspeter FREHNER, Sevelen (CH); Michael ZICKAR, Englburg (CH)

(73) Assignee: VAT Holding AG, Haag (CH)

(21) Appl. No.: 15/121,562

(22) PCT Filed: Feb. 6, 2015
(86) PCT No.: PCT/EP2015/052499

§ 371 Date: Aug. 25, 2016

(30) Foreign Application Priority Data
Feb. 26, 2014 (EP) 14156772.7

(51) Int. Cl. F16K 51/02; F16K 3/18; B01D 46/00; B01D 39/20; B01D 39/08; F16K 3/02; F16K 3/314

(52) U.S. Cl. CPC F16K 51/02; F16K 3/0218; F16K 3/0227; F16K 3/18; F16K 3/314; B01D 39/2044; B01D 39/08; B01D 46/0012; B01D 2239/0613

(57) ABSTRACT

The invention relates to a vacuum valve having a screw element for coupling a first component of the vacuum valve to a second component. The screw element has a force transfer surface section between a threaded surface section having a first thread and an engagement surface section, arranged in a first gas region, for a tool. The first and second component are coupled by a thread engagement, carried out through a passage hole in the first component, between the first thread and a second thread assigned to the second component. The screw element has a sealing surface section between the threaded surface section and the engagement surface section. Between the sealing surface section and a sealing face of the first component, a sealing seal element is arranged so the first gas region is separated in a gas-tight or particle-tight manner from a third gas region.

The invention relates to a vacuum valve according to the preamble of claim 1 and to a screw element for a vacuum valve according to the preamble of claim 19.

Vacuum valves for the substantially gas-tight closing of a flow path guided through an opening formed in a valve housing are known in general in different embodiments from the prior art.

Vacuum gate valves are used in particular in the field of IC and semiconductor manufacture, which must take place in a protected atmosphere, where possible without the presence of contaminating microparticles. By way of example, the highly sensitive semiconductor or liquid-crystal elements, in a manufacturing facility for semiconductor wafers or liquid-crystal substrates, pass through a number of process chambers in sequence, in which the semiconductor elements disposed within the process chamber are machined by means of a machining apparatus. Both during the machining procedure within the process chamber and during the transport from process chamber to process chamber, the highly sensitive semiconductor elements must always be in a protected atmosphere—in particular in a vacuum.

The process chambers are connected to each other by way of example via connecting passages, wherein the process chambers can be opened by means of vacuum gate valves in order to transfer the parts from one process chamber to the next and can then be closed in a gas-tight manner in order to carry out the particular manufacturing step. Valves of this type are also referred to as vacuum transfer valves on account of the described field of application and are also referred to as rectangular gate valves on account of their rectangular opening cross section.

Since transfer valves are used, inter alia, in the production of highly sensitive semiconductor elements, the particle generation caused in particular by the actuation of the valve and by the mechanical loading of the valve closure member and also the number of free particles in the valve chamber must be kept as low as possible. Particle generation is primarily a result of friction, by way of example by metal-on-metal contact and by abrasion.

Depending on the particular drive technologies, a distinction is made in particular between gate valves (also referred to as valve gates or rectangular gate valves) and shuttle valves, wherein the closing and opening of the valve usually occurs in two steps in the prior art. In a first step a valve closure member, in particular a closure disk, in the case of a gate valve, and as known by way of example from U.S. Pat. No. 6,416,037 (Geiser) or from U.S. Pat. No. 6,056,266 (Blecha), in particular of the L-type, is displaced linearly over an opening substantially parallel to the valve seat, or, in the case of a shuttle valve, as is known by way of example from U.S. Pat. No. 6,089,537 (Olmsted), is pivoted about a pivot axis over the opening, without any contact between the closure disk and the valve seat of the valve housing. In a second step the closure disk is pressed by means of the closure side thereof against the valve seat of the valve housing, such that the opening is closed in a gas-tight manner. The sealing effect can be provided for example either via a seal arranged on the closure side of the closure disk, which seal is pressed against the valve seat running around the opening, or via a ring seal on the valve seat, against which ring seal the closure side of the closure disk is pressed. The seal, in particular the ring seal, can be held and/or cured-on in a groove.

Different sealing devices are known from the prior art, by way of example from U.S. Pat. No. 6,629,682 B2 (Duelli). A suitable material for ring seals and seals in vacuum valves is, by way of example, fluorinated rubber, also referred to as FKM, in particular the fluoroelastomer known under the trade name Viton®, and also perfluorinated rubber, or FFKM for short.

The described two-stage movement, in which the closure member is first slid transversely over the opening without the seal coming into contact with the valve seat, and the closure member is then pressed substantially perpendicularly against the valve seat, has the primary advantage, besides the possibility of precise regulation of the flow rate, that the seal is pressed practically exclusively perpendicularly without any transverse or longitudinal loading of the seal. Either a single drive which enables an L-shaped movement of the closure member or a plurality of drives, for example two linear drives or a linear drive and a spreading drive, is/are used for this purpose.

In addition, gate valves in which the closing and sealing operation is indeed performed via a single linear movement, but the sealing geometry is such that a transverse loading of the seal is altogether avoided, are known. A valve of this type is known by way of example by the product name “MONOVAT series 02 and 03” and as a transfer valve, embodied as a rectangular insert valve, by the company VAT Vakuumteiler AG in Haag, Switzerland. The structure and operating principle of a valve of this type are described by way of example in U.S. Pat. No. 4,809,950 (Geiser) and U.S. Pat. No. 4,881,717 (Geiser).

The valve described there has, in its housing, a sealing face which, as considered in the direction of the axis of the valve through-opening, has portions arranged one behind the other and which transition, via continuous curves, into flat sealing face portions extending laterally outwards, wherein the imaginary generators of this sealing face, which is formed in one part but has a plurality of portions, lie parallel to the axis of the valve through-opening.

A suitable drive for a transfer valve of this type which can be closed by means of a linear movement is presented in JP 6241344 (Buriida Fuuberuto). The drive described there has eccentrically mounted levers for linear displacement of the connecting rods on which the closure member is mounted.

In a widespread embodiment of the above-mentioned valve types, the closure member and the valve drive are connected via at least one displacement arm, in particular a connecting rod or valve rod. Here, the rigid displacement arm is rigidly connected via one of its ends to the closure member and is rigidly connected via its other end to the valve drive. The closure disk is, in most valves, connected to the at least one connecting rod by means of screwing.

CH 699 258 B1 describes a vacuum valve comprising a closure disk, in which at least one rod receptacle is formed, and at least one connecting rod, on which the closure disk is removably mounted via a connecting portion of the connecting rod engaging in the rod receptacle. The rock receptacle is formed as a blind hole, in which the connecting rod is inserted via its connecting portion. The closure disk has a clamping element, which projects in a displaceable manner into the blind hole and is formed in such a way that a clamping connection exists between the closure disk and the connecting portion and can be released by the displacement of the clamping element. A ring seal sealing against particles is arranged between the blind hole and the connecting rod in such a way that particles produced by the clamping connection are prevented from leaving the blind hole, whereby the number of undesirable particles in the valve chamber caused by material friction is kept low and it is made possible to assemble and disassemble the closure disk on the at least one connecting rod quickly and comfortably.

DE 10 2008 061 315 B4 describes a mounting of a valve plate on a valve rod by means of a crosspiece extending transversely with respect to the valve rod. The crosspiece is connected at a middle connection point to the valve rod, in particular by a screw, and is connected at least at two lateral connection points, which are disposed on both sides of the middle connection point, to the valve plate, in particular by means of screwing. The crosspiece is at a distance from the valve plate in a middle portion, which comprises the middle connection point and portions of the crosspiece adjoining said connection point on both sides. By means of this mounting of simple design, a certain pivoting motion, for example in the region of 1°, of the valve plate relative to the valve rod about a pivot axis arranged at right angles to the valve rod is made possible by means of a twisting of the crosspiece. A very simple design can thus be achieved. The crosspiece can preferably be formed in one piece and in particular completely from metal.

U.S. Pat. No. 6,471,181 B2 describes a similar mounting. A crosspiece to be connected to the valve rod comprises a first plate which has a conical opening for receiving the end of the valve rod which is screwed to the first plate. Resilient bearing blocks are attached to the first plate on both sides of the middle point of connection to the valve rod, and second plates are attached to the sides of said bearing blocks opposite the first plate, which second plates are each screwed to the valve plate. By means of these resilient bearing blocks, tilting about an axis arranged at right angles to the valve rod is made possible, such that a more uniform pressing of the seal of the valve plate against the valve seat is achieved.

US 2008/0066811 A1 describes a vacuum valve in which a valve plate is connected to first and second crosspieces. The crosspieces are connected to the valve plate via connection members. These have connection arms extending in the longitudinal direction of the crosspiece on both sides of a point of connection to the crosspiece, which connection arms are connected at their ends to a connection limb extending jointly in the longitudinal direction of the crosspiece, said connection limb being screwed to the valve plate at a number of points distanced in the longitudinal direction of the crosspiece. A more uniform transfer of force in the longitudinal direction of the crosspiece is to be achieved as a result.

A feature common to these embodiments is that a closure member disposed within the vacuum region of the vacuum valve is directly connected to a displacement arm of the valve drive by means of least one screw connection likewise arranged within this vacuum region, or is connected indirectly to a displacement arm of the valve drive, in particular via a crosspiece.

Screw connections within a vacuum region pose a risk of what is known as a virtual internal vacuum leak, since certain parts of the thread of the screw connection are closed off from the rest of the surrounding environment in an airtight manner to a varying extent when the inner valve chamber is evacuated, and therefore the gas remaining in some instances in the thread escapes slowly following the evacuation and contaminates the inner valve chamber. For this reason, connection channels and slots leading into the threaded portions have been created in the prior art, whereby the threads are vented. Thus, no gas can remain in the thread in the event of evacuation.

In other words, certain measures are taken in the case of vacuum valves in order to avoid any inner gas regions which are disposed within the vacuum region of a vacuum valve and are enclosed by the vacuum region, by venting these inner gas regions in particular by means of venting bores and thus connecting them to the vacuum region. In the case of screw connections, this occurs by means of the described connection channels or slots.

This deliberate thread venting is known in the case of screw connections within a vacuum region in vacuum valves and is already used in valve types found on the market.

It has been found, however, that this deliberately created thread venting in order to avoid virtual inner vacuum leaks can be disadvantageous to a certain extent, particularly with desired or undesired minimal relative movements between the parts connected by means of the screw connection, since small friction particles in the form of microparticles are produced within the thread and escape through the venting channels or slots and contaminate the interior of the valve. This is particularly the case with metal threads. This results in a negative influencing of the manufacturing process. In the case of conventional screw connections in the vacuum field, the relative movement of the threaded parts is so low, however, that particle generation was previously considered to be negligible.

With some connection types, however, a relative movement in the thread is unavoidable. A relative movement of this type in the thread and a resultant particle generation can result in particular with the above-described valve type described in DE 10 2008 061 315 B4, since with this valve there is a deliberate resilient deformation of the crosspiece in order to enable a pivoting motion about the virtual pivot axis.

Screw connections within a vacuum region of a vacuum valve generally pose the risk of generating undesirable, process-damaging friction particles in the form of microparticles, which are created as a result of a relative movement between the threads.

The object of the invention is therefore to provide a vacuum valve having a screw element in the vacuum region for connecting a first component part of the vacuum valve to a second component part in a mechanically coupling manner, and also a screw element suitable for this purpose, by means of which the number of friction particles within the vacuum region produced by material friction in the thread of the screw connection is kept low.

This object is achieved by the realization of the features in the independent claims. Features which further develop the invention in an alternative or advantageous way can be inferred from the dependent claims.

To summarize, the invention comprises a vacuum valve having a screw element for connecting a first component part of the vacuum valve to a second component part in a mechanically coupling manner. The screw element has a force transfer surface portion between a threaded surface portion having a first thread and an engagement surface portion for a tool, which engagement surface portion is arranged in a first gas region. The first component part and the second component part can be mechanically coupled in a form-fitting manner by a threaded engagement between the first thread and a second thread assigned to the second component part, said threaded engagement being carried out through a through-hole in the first component part. The screw element has a sealing surface portion between the threaded surface portion and the engagement surface portion.

In accordance with the invention a sealing seal element is arranged between the sealing surface portion and a sealing face of the first component part in such a way that the first gas region is separated, in a manner sealing against gas or particles, from a third gas region, in which the threaded surface portion is arranged.

In order to avoid a contamination of the valve interior by friction particles produced in the thread of a screw connection disposed in the valve interior, a measure is thus taken which initially appears to go against the teaching in the prior art, in accordance with which the thread should be vented in order to avoid virtual internal vacuum leaks.

In accordance with the invention the screw connection disposed in the valve interior is encapsulated in a gas-tight or particle-tight manner by means of at least one seal. The threaded region of the screw connection is thus sealed off within the valve interior in a gas-tight or particle-tight manner from the rest of the region. Within the vacuum region, an isolated region is thus deliberately created for the threaded connection to be encapsulated, so as to prevent particles from leaving this region.

The vacuum valve according to the invention comprises a closure member, which in particular is formed as a closure plate, closure disk, or as a closure bar.

The closure member has a closure face for the gas-tight closing of an opening connecting a first gas region to a second gas region. This closure face is in particular formed by a front side of the closure member. The opening is formed in particular in a valve wall or in the housing of the valve. If the closure member closes the opening, the closure member thus separates the first gas region on one side of the opening from the second gas region on the other side of the opening. In an open position of the closure member, the first gas region and the second gas region are indeed connected to each other via the open opening and form a common gas region, however these two gas regions will be considered hereinafter, even in the open position of the closure member, as geometrical and separate gas regions which border one another at a geometrical interface spanned by the closure face in the closed position of the closure member.

The vacuum valve is formed by way of example as a transfer valve having an opening cross section which in particular is substantially rectangular and having a planar, in particular likewise substantially rectangular closure bar, wherein the closure member, as described above, can be displaced by means of a one-stage or two-stage movement.

The closure member is arranged on at least one displacement arm, which in particular is formed by a connecting rod extending linearly or in a curved manner or by a valve rod, and which in particular extends along a geometrical displacement axis.

In order to displace the closure member, a drive unit is mechanically coupled to this displacement arm. This drive unit is arranged and designed in such a way that the closure member in the first gas region can be displaced back and forth, by displacement of the displacement arm by means of the drive unit, between an open position and a closed position. The closure member is thus movable within the first gas region. In the open position the closure member releases the opening, whereas the closure face of the closure member closes the opening in a gas-tight manner in the closed position and separates the first gas region from the second gas region in a gas-tight manner. In particular, an edge portion of the closure face rests in a gas-tight manner on a valve seat encircling the opening, wherein a seal for producing gas-tight contact is fixed in this edge region or on the valve seat.

The vacuum valve additionally has a screw element for connecting a first component part of the vacuum valve, which first component part is arranged at least in part in the first gas region, to a second component part in a mechanically coupling manner. The first component part is a component part of the vacuum valve, whereas the second component part can also be assigned to another unit, by way of example a vacuum chamber. However, the second component part can also be a component part of the vacuum valve. The first component part or the second component part is mechanically coupled to the drive unit. In particular, one of the two component parts is a component part which can be mechanically moved or driven by the drive unit. Alternatively, one of the two component parts is mechanically coupled indirectly or directly to a housing of the drive unit.

In particular, the first component part is formed by the displacement arm and the second component part is formed by the closure member, or vice versa, i.e. the first component part is formed by the closure member and the second component part is formed by the displacement arm, wherein the displacement arm and the closure member are connected by means of the screw element.

The outer surface of the screw element, i.e. the surface delimiting the screw element geometrically outwardly, is divided into a number of functional and/or structural portions, specifically at least into a threaded surface portion, an engagement surface portion, and a force transfer surface portion disposed therebetween and separating said threaded and engagement surface portions. All surface portions preferably extend annularly around a first axis of the screw element.

A first thread extending around a geometrical first axis is formed on the threaded surface portion. This first thread may be an external thread or an internal thread. A thread is generally understood to mean a profiled notching, that is to say a thread turn, in the screw element which extends continuously in a spiraled manner around a cylindrical wall externally or internally in a helix.

The engagement of this design is formed on the engagement surface portion, such that the screw element is rotatable and/or secured in a form-fitting manner against rotation about the first axis, in particular by means of a tool which can engage in a form-fitting manner in the engagement. The engagement surface portion arranged in the first gas region can be formed by way of example by an internal or external polygon socket, in particular a hexagon or square socket, a multi-tooth socket, a 12-point socket, or a socket having multiple rounded edges, and also a slot or cross slot. In other words this engagement surface portion is shaped in such a way that a torque about the first axis of the screw element can be transferred by means of a form-fitting engagement between the screw element and an engagement element engaging in this engagement surface portion. This engagement element can be a tool or an anti-rotation protection means, for example.

The force transfer surface portion, which is arranged between the threaded surface portion and the engagement surface portion, points at least in part in a screw closing direction extending along the first axis. This force transfer surface portion is formed by way of example by a step or a shoulder, which protrudes radially outwardly beyond the first thread.

The first component part has a through-hole extending along the first axis, in particular a through-bore. The through-hole can have any cross section, and in particular is round. The through-hole is surrounded, in particular annularly enclosed, by a contact face which points at least in part in a screw opening direction, which is opposite the screw closing direction. The contact face and the force transfer surface portion are formed for mutual contact and force transfer in a direction parallel to the first axis.

The first component part and the second component part can be, or are mechanically coupled in a form-fitting manner by means of a threaded engagement, occurring through the through-hole, between the first thread of the screw element and a second thread assigned to the second component part, and also by resting the force transfer surface portion on the contact face of the first component part. In other words, the first component part and the second component part can be, or are connected to each other in a form-fitting manner by means of the screw element, wherein disconnection occurs via a threaded engagement between the first thread of the screw element and the second thread, which is mechanically coupled to the second component part.

In accordance with the invention the screw element has a sealing surface portion. This sealing surface portion is arranged between the threaded surface portion and the engagement surface portion, encloses the first axis, and separates the threaded surface portion and the engagement surface portion from one another. The sealing surface portion preferably lies axially between the threaded surface portion and the engagement surface portion with respect to the first axis.

The first component part has, adjacently to the contact face, a sealing face enclosing the through-hole. A sealing seal element enclosing the first axis is arranged between the sealing surface portion of the screw element and the sealing face of the first component part in such a way that the first gas region is separated from a third gas region, in which the threaded surface portion is arranged. In other words, the sealing face and the sealing surface portion are designed and arranged in such a way that an interposed seal element, which is fixed either on the sealing face or the sealing surface portion, separates the first gas region, in which the engagement surface portion of the screw element is arranged, from the third gas region, in which the threaded surface portion is arranged, in a manner sealing against gas or particles.

The seal element extending annularly around the first axis thus forms a gas-tight or particle-tight connection between the sealing surface portion and the sealing face, such that this seal element forms a gas-tight or particle-tight separation between the first gas region and the third gas region.

By means of this separation between the first gas region, in which the closure member is disposed and which is to be kept free from process-damaging friction particles, and the third gas region, in which the threaded surface portion having the first thread is arranged, friction particles created within the third gas region by means of a relative movement between the first thread of the screw element and the second thread, which is assigned to the second component part, are prevented from penetrating the first gas region. It is thus possible in accordance with the invention to keep low the number of potentially process-damaging friction particles disposed in the first and second gas region, since these friction particles remain in the third gas region.

The sealing surface portion can be arranged in one embodiment between the force transfer surface portion and the engagement surface portion in such a way that the force transfer surface portion is in the third gas region. In this case, friction particles which are created by a relative movement between the force transfer surface portion and the contact face are also prevented from infiltrating the first gas region. Alternatively, however, it is also possible for the sealing surface portion to be arranged between the force transfer surface portion and the threaded surface portion.

One variant of the invention makes provision for the first component part to have an inner lateral surface pointing at least in part inwardly toward the first axis and forming the sealing face. The screw element has an outer lateral surface pointing it at least in part outwardly and forming the sealing surface portion. The outer lateral surface and/or the inner lateral surface have/has in particular the geometrical shape of a geometrical straight circular cylinder lateral surface or of a geometrical straight circular cone lateral surface. The inner lateral surface and the outer lateral surface preferably have the common geometrical first axis.

In a first special variant, the inner lateral surface has the geometrical shape of a geometrical straight circular cylinder lateral surface, which in particular is formed by a counterbore in the first component part, which counterbore is arranged axially adjacently to the through-hole and extends around the first axis. In a second special variant, the inner lateral surface has the geometrical shape of a geometrical straight circular cone lateral surface, which in particular is formed by a countersink in the first component part, which countersink is arranged axially adjacently to the through-hole and extends around the first axis.

The seal element can be fixed on the sealing surface portion of the screw element. In particular, the seal element can be formed as an O-ring, wherein the sealing surface portion has a peripheral groove, in which this O-ring is fixed. Alternatively, the seal element can be formed as a cured-on seal and can be cured on, on the sealing surface portion.

In accordance with the invention, there is alternatively also the possibility that the seal element is fixed on the sealing face of the first component part. The seal element can be formed as an O-ring, wherein the sealing face has a peripheral groove, in which the O-ring is fixed, or the seal element is a seal that is cured on, on the sealing face.

The seal element, in accordance with the invention, can seal either against gas or against particles. If the seal element seals against gas, it is arranged between the sealing surface portion and the sealing face in such a way that the first gas region is separated from the third gas region in a gas-tight manner. For this purpose, the seal element preferably consists of a material suitable for vacuum-tight sealing. In particular, the seal element consists substantially of elastomer, in particular rubber. Suitable rubbers are in particular fluorinated rubber, also referred to as FKM, or perfluorinated rubber, also referred to as FFKM.

In the case of a gas-tight separation between the first gas region and the third gas region, there is no gas exchange between the third gas region, which is loaded with particles, and the first gas region, which is to be kept free from particles, whereby the particle load in the first gas region can be kept low. However, on account of the gas-tight separation, a pressure difference can form between the first gas region and the third gas region. The gas-tight seal is therefore to be embodied preferably in such a way that the gas-tight and thus also particle-tight separation is ensured, even with the prevailing pressure differences between the first gas region and the third gas region.

Alternatively, however, there is also the possibility in accordance with the invention to design the seal element so as to seal against particles. In this case, the seal element is formed so as to seal against particles, in such a way that microparticles disposed in the third gas region having a particle size of more than 1 or 0.1 or 0.01 micrometers are substantially blocked by the seal element and are substantially prevented from infiltrating the first gas region. In particular, this seal element is formed as a filter, in particular as a HEPA filter, for filtering out microparticles having a particle size of more than 1 or 0.1 or 0.01 micrometers, in particular with a degree of separation of more than 85% or 95% or 99% or 99.5% or 99.95%. By way of example, the seal element consists of a fiber material or a metallic material, in particular a sintered or woven metallic material. In particular, it consists of a microporous, in particular sintered, thin-fibered or spun material, in particular microporous or thin-fibered, in particular spun polytetrafluoroethylene. However, the seal element can also be formed by a microporous metallic filter. The particle size is in particular the geometrical or physical equivalent diameter of a particle.

One advantage of this particle-tight, but not necessarily gas-tight separation lies in the fact that, by means of a filtered gas exchange between the first gas region and the third gas region, a particle exchange and also pressure differences between these gas regions can be avoided. The risk of an internal virtual leak in the valve interior is reduced by the avoidance of a pressure difference.

However, the same effect can also be attained by means of a connection opening connecting the first gas region and the third gas region to each other, wherein a filter element is arranged in the connection opening or at the connection opening. This filter element is designed so as to seal against particles, in such a way that microparticles disposed in the third gas region having a particle size of more than 1 or 0.1 or 0.01 micrometers are substantially blocked by the filter element and are substantially prevented from infiltrating the first gas region. In particular, the filter element is designed to filter out microparticles having a particle size of more than 1 or 0.1 or 0.01 micrometers, in particular with a degree of separation of more than 85% or 95% or 99% or 99.5% or 99.95%, for example in the form of a HEPA filter.

This filter element can consist of the same materials as the above-described seal elements sealing against particles. The pressure-compensating and particle-tight connection opening is advantageous particularly with use of a seal element sealing against gas, so as to avoid pressure differences between the first gas region and the third gas region.

In a special embodiment the connection opening and the filter element are arranged in the screw element.

The screw element can be formed in particular as a screw or nut.

If the screw element is a screw having a threaded portion and a screw head, the threaded surface portion is arranged on the threaded portion guided through the through-hole in the first component part. The engagement surface portion, the force transfer surface portion and the sealing surface portion are disposed on the screw head. In particular, the first thread of the screw element is formed as a first external thread and the second thread assigned to the second component part is formed as a second internal thread, however a reverse design is also possible. By way of example, the second thread is formed in a blind hole in the second component part. In particular, the screw head is formed as a cylinder screw head.

If the screw element is a nut, the second thread is formed in particular on a threaded pin of the second component part guided through the through-hole. In particular, the first thread is formed as a first internal thread and the second thread is formed as a second external thread. A reverse design is possible. By way of example, the first thread is formed in a blind hole in the nut, wherein the nut can be formed as a cap nut.

In one possible embodiment the third gas region, in which the threaded surface portion is arranged, is arranged within the first gas region and is separated therefrom, in particular in a gas-tight or particle-tight manner. This third gas region is thus fully enclosed by the first gas region. Alternatively, however, there is also the possibility for the third gas region and the first gas region to border one another and be separated by the seal element.

In a further development of the invention a second seal element sealing against gas or particles and formed in particular as a second O-ring is arranged sealingly between the first component part and the second component part. This second seal element additionally separates the first gas region and the third gas region in the region between the first and second component part in a gas-tight or particle-tight manner and in particular encloses the through-hole.

In a further development of the invention the drive unit is formed in such a way that the closure member can be displaced, by displacement of the displacement arm in an axial direction parallel to the displacement axis by means of the drive unit, between the open position and an intermediate position, and can be displaced, in a direction transverse to the displacement axis, between the intermediate position and the closed position. In the open position the closure member releases the opening. In an intermediate position the closure face covers the opening and is at a distance from and opposite a valve seat surrounding the opening. In the closed position the closure face closes the opening in a gas-tight manner and separates the first gas region from the second gas region in a gas-tight manner.

A crosspiece extending transversely to the displacement axis is connected to the displacement arm at a middle connection point. The crosspiece is connected to the closure member, on a rear side of the closure member opposite the closure face, at least at two lateral connection points disposed on both sides of the middle connection point. The crosspieces are at a distance from the rear side in a middle portion, which comprises the middle connection point and portions adjoining this connection point on both sides thereof and which extends between the lateral connection points. In addition, the crosspiece is resilient, in such a way that, by means of a twisting of the crosspiece, the closure member can be pivoted relative to the displacement arm about a pivot axis arranged at right angles to the displacement axis, and in particular is formed in one piece. A mounting of this type of a closure member on a displacement arm by means of a crosspiece extending transversely to the displacement arm is described in DE 10 2008 061 315 B4.

A further development of the invention makes provision for the middle connection point of the crosspiece to comprise the described screw element, wherein the first component part is formed by the displacement arm and the second component part is formed by the crosspiece, or vice versa, i.e. the first component part is formed by the crosspiece and the second component part is formed by the displacement arm.

Alternatively or additionally, the lateral connection points can each comprise a screw element, wherein the first component part is formed by the closure member and the second component part is formed by the crosspiece, or the first component part is formed by the crosspiece and the second component part is formed by the closure member.

However, the first component part can also be formed by the drive unit and the second component part can also be formed by a wall, which comprises the opening, or vice versa. In this case, the screw connection is used between the wall, which comprises the opening, and the drive unit.

In addition, the invention comprises a screw element, in particular a screw or a nut, for the described vacuum valve according to the invention. The screw element has a threaded surface portion, engagement surface portion, a force transfer surface portion, and an end surface portion.

The threaded surface portion has a first thread extending around a geometrical first axis.

An engagement of this design is formed on the engagement surface portion, such that the screw element is rotatable and/or secured in a form-fitting manner against rotation about the first axis, in particular by means of a tool which can engage in a form-fitting manner in the engagement.

The force transfer surface portion is arranged between the threaded surface portion and the engagement surface portion and points at least in part in a screw closing direction extending along the first axis.

The end surface portion is opposite the engagement surface portion and points at least in part in the screw closing direction, wherein the threaded surface portion is arranged between the end surface portion and the force transfer surface portion.

In accordance with the invention the screw element has a sealing surface portion arranged between the threaded surface portion and the engagement surface portion. The sealing surface portion separates the threaded surface portion and the engagement surface portion from one another and encloses the first axis. A seal element is fixed on the sealing surface portion of the screw element.

The seal element consists preferably substantially of an elastomer, in particular rubber, in particular fluorinated rubber or perfluorinated rubber. The seal element can be formed as an O-ring, wherein the sealing surface portion has a peripheral groove, in which the O-ring is fixed. Alternatively, the seal element is formed as a cured-on seal and is cured on, on the sealing surface portion.

A connection opening is formed between the engagement surface portion and the end surface portion. A filter element is arranged in this connection opening. As already described above in conjunction with the vacuum valve, the filter element can be designed to filter out particles having a particle size of more than 1 or 0.1 or 0.01 micrometers, in particular with a degree of separation of more than 85% or 95% or 99% or 99.5% or 99.95%, in particular in the form of a HEPA filter. The filter element consists of a fiber material or a metallic material, in particular a sintered or woven metallic material. The screw element has in particular an outer lateral surface pointing at least in part outwardly and forming the sealing surface portion, which outer lateral surface in particular has the geometrical shape of a geometrical straight circular cylinder lateral surface or of a geometrical straight circular cone lateral surface.

The vacuum valve according to the invention and the screw element according to the invention will be described in greater detail hereinafter purely by way of example on the basis of specific exemplary embodiments schematically illustrated in the drawings.

In the drawings, more specifically:

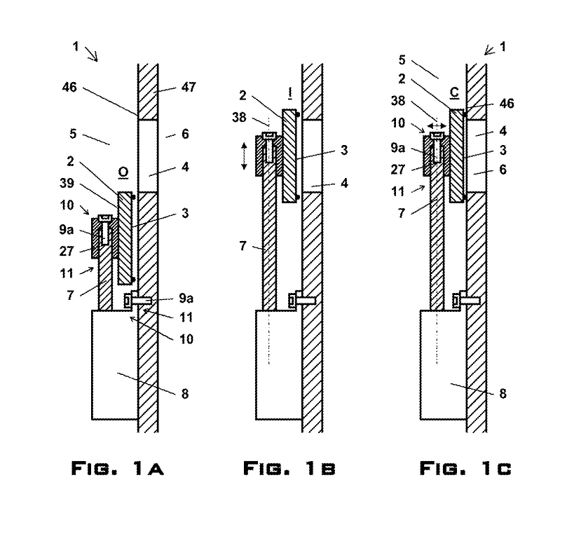

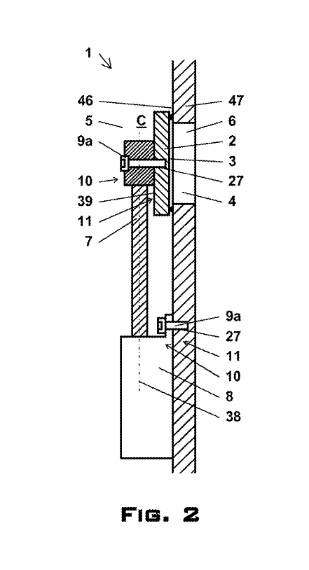

FIG. 1a shows a cross-sectional view from the side of a first embodiment of the vacuum valve in an open position;

FIG. 1b shows the cross-sectional view from the side of the first embodiment of the vacuum valve in an intermediate position;

FIG. 1c shows the cross-sectional view from the side of the first embodiment of the vacuum valve in a closed position;

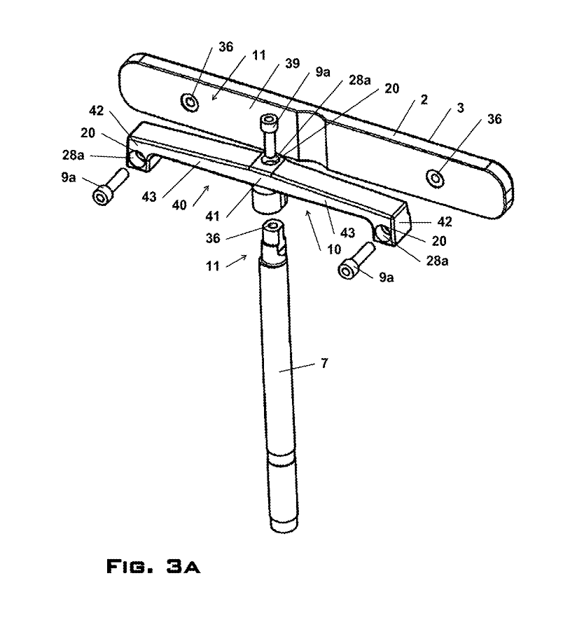

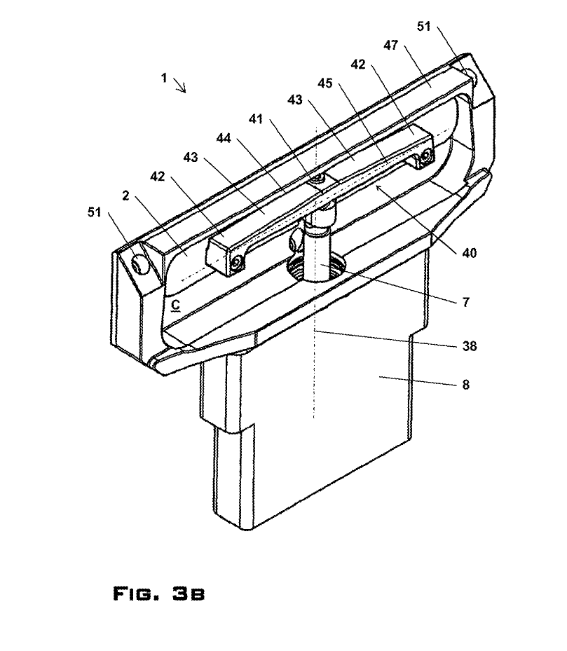

FIG. 2 shows a cross-sectional view from the side of a second embodiment of the vacuum valve in a closed position;

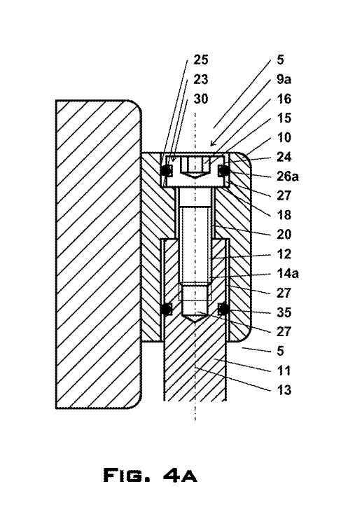

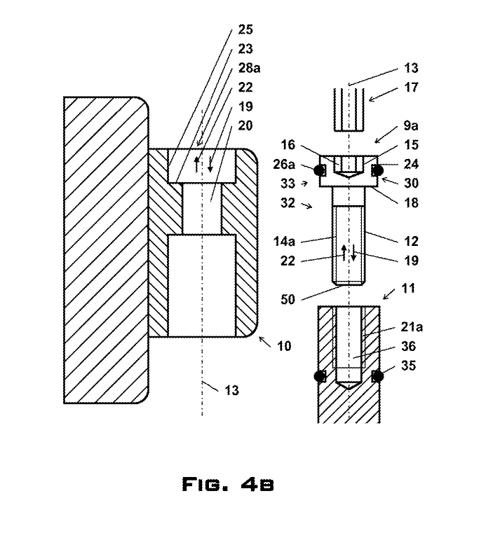

FIG. 3a shows an oblique view of a closure member, a crosspiece, and a displacement arm of a third embodiment of the vacuum valve;

FIG. 3b shows an oblique view of the third embodiment of the vacuum valve;

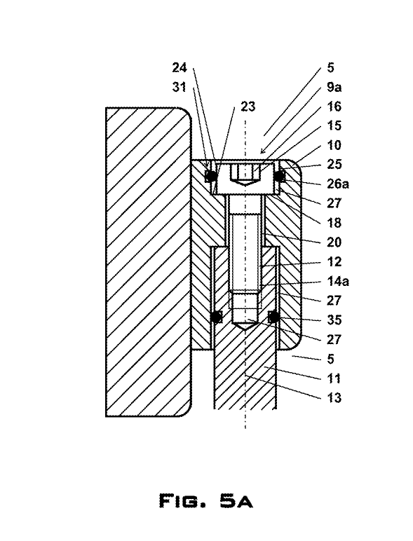

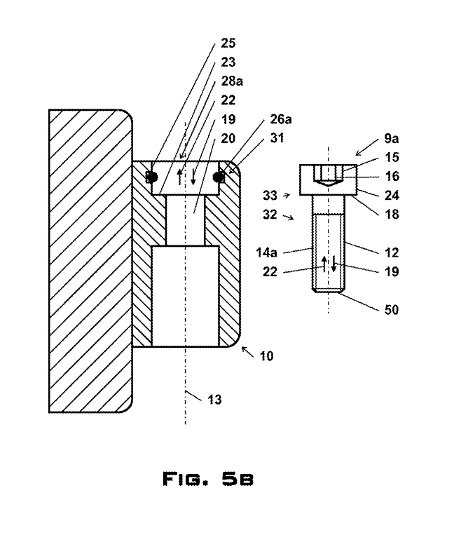

FIG. 4a shows a detailed cross-sectional view from the side of a first component part, a second component part, and a screw of a fourth embodiment of the vacuum valve in the coupled state with an O-ring fixed in the peripheral groove of the screw;

FIG. 4b shows a detailed cross-sectional view from the side of the first component part, the second component part, and the screw of the fourth embodiment of the vacuum valve in the decoupled state with the O-ring fixed in the peripheral groove of the screw;

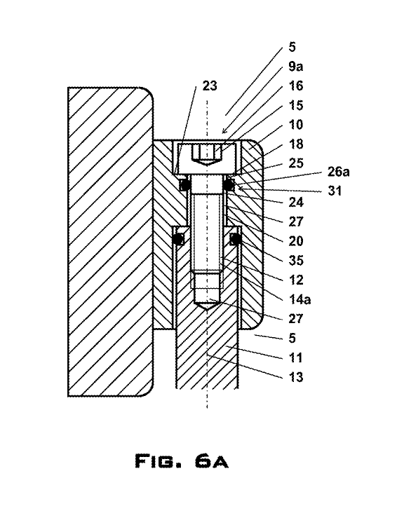

FIG. 5a shows a detailed cross-sectional view from the side of a first component part, a second component part, and a screw of a fifth embodiment of the vacuum valve in the coupled state with an O-ring fixed in a peripheral groove of a counterbore of the first component part;

FIG. 5b shows a detailed cross-sectional view from the side of the first component part, the second component part, and the screw of the fifth embodiment of the vacuum valve in the decoupled state with the O-ring fixed in the counterbore of the peripheral groove of the first component part;

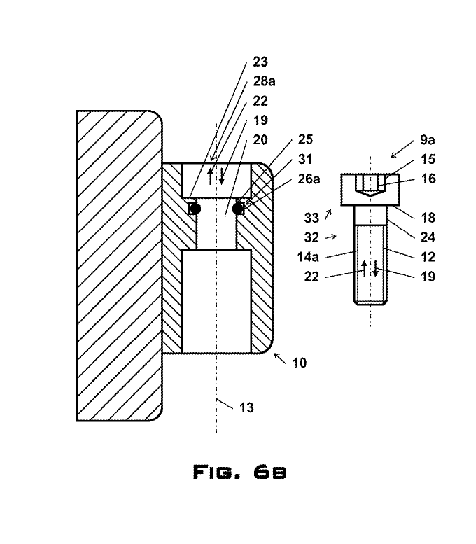

FIG. 6a shows a detailed cross-sectional view from the side of a first component part, a second component part, and a screw of a sixth embodiment of the vacuum valve in the coupled state with an O-ring fixed in the peripheral groove of a through-hole of the first component part;

FIG. 6b shows a detailed cross-sectional view from the side of the first component part, the second component part, and the screw of the sixth embodiment of the vacuum valve in the decoupled state with the O-ring fixed in the peripheral groove of the through-hole of the first component part;

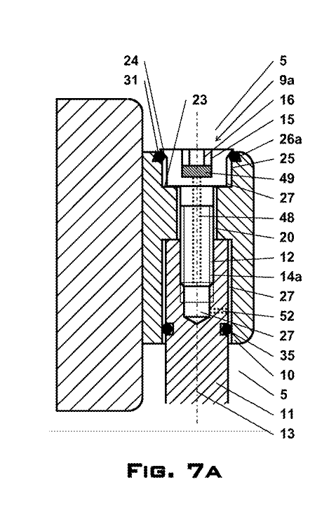

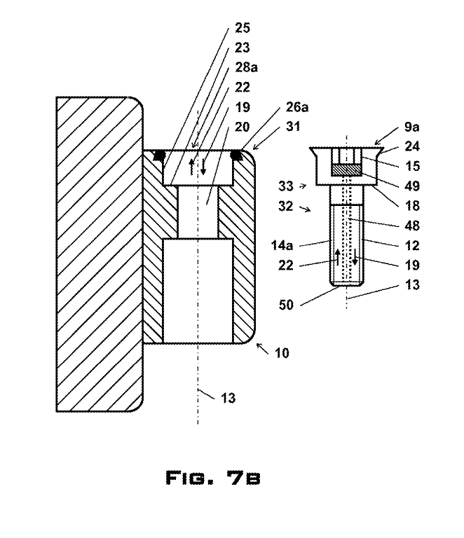

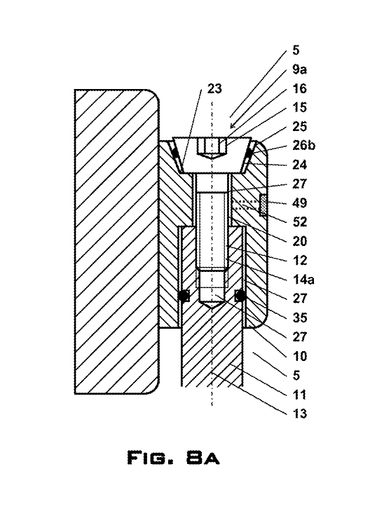

FIG. 7a shows a detailed cross-sectional view from the side of a first component part, a second component part, and a screw of a seventh embodiment of the vacuum valve in the coupled state with a connection opening and a filter element in the screw;

FIG. 7b shows a detailed cross-sectional view from the side of a first component part, a second component part, and a screw of a seventh embodiment of the vacuum valve in the decoupled state with a connection opening and a filter element in the screw;

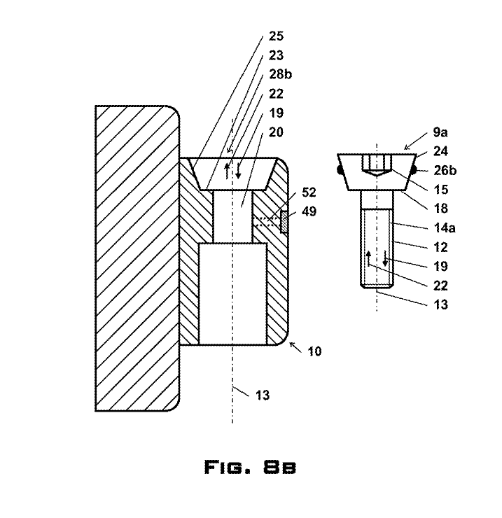

FIG. 8a shows a detailed cross-sectional view from the side of a first component part, a second component part, and a screw of an eighth embodiment of the vacuum valve in the coupled state with a countersink in the first component part and with a seal cured onto the screw;

FIG. 8b shows a detailed cross-sectional view from the side of a first component part, a second component part, and a screw of an eighth embodiment of the vacuum valve in the decoupled state with the countersink in the first component part and with a seal cured onto the screw;

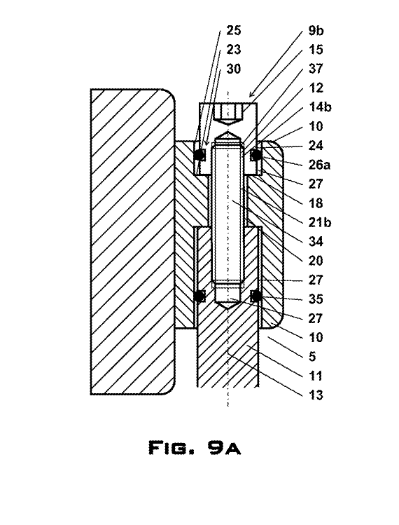

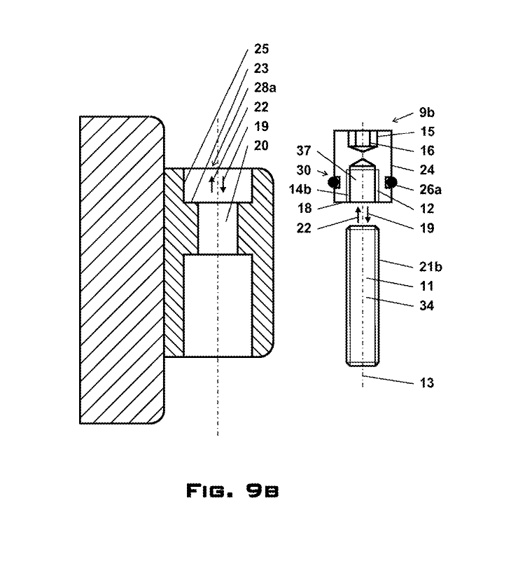

FIG. 9a shows a detailed cross-sectional view from the side of a first component part, a threaded pin of a second component part, and a nut of a ninth embodiment of the vacuum valve in the coupled state with an O-ring fixed in a peripheral groove of the nut; and

FIG. 9b shows a detailed cross-sectional view from the side of the first component part, the threaded pin of the second component part, and the nut of the ninth embodiment of the vacuum valve in the decoupled state with the O-ring fixed in the peripheral groove of the nut.

The figures show nine different embodiments of the vacuum valve according to the invention in different states, from different views, and in different levels of detail. The embodiments differ from one another partly merely with regard to certain features, and therefore the figures will be described jointly hereinafter and in some instances only the differences between the embodiments will be discussed. Reference signs and features already explained in any previous figures will not always be discussed again.

In FIGS. 1a, 1b and 1c a vacuum valve 1 in the form of a transfer valve is illustrated. This transfer valve is a particular form of gate valve. The vacuum valve 1 has a rectangular, planar closure member 2, which has a closure face 3 for closing an opening 4 in a gas-tight manner. The opening 4 has a cross section corresponding to the closure member 2 and is formed in a wall 47. The opening 4 is surrounded by a valve seat 46.

The opening 4 connects a first gap region 5, which is disposed to the left of the wall 47 in FIGS. 1a, 1b and 1c, to a second gas region 6, which is arranged to the right of the wall 47.

The closure member 2 is arranged on a displacement arm 7, which is rod-shaped and extends along a geometric displacement axis 38. The displacement arm 7 is mechanically coupled to a drive unit 8, by means of which the closure member 2 in the first gas region 5 to the left of the wall 47 can be displaced, by displacement of the displacement arm 7 by means of the drive unit 8, between an open position O (FIG. 1a), via an intermediate position I (FIG. 1b), into a closed position (FIG. 1c).

In the open position O, the closure member 2 is disposed outside the projection region of the opening 4 and releases said opening completely, as shown in FIG. 1a.

By displacing the displacement arm 7 in the axial direction parallel to the displacement axis 38 and parallel to the wall 47, the closure member 2 can be displaced by means of the drive unit 8 from the open position O into the intermediate position I.

In this intermediate position I, the closure face 3 covers the opening 4 and is disposed at a distance from and opposite the valve seat 46 surrounding the opening 4, as shown in FIG. 1b.

By displacing the displacement arm 7 in a direction transverse to the displacement axis 38, i.e. perpendicularly to the wall 47 and to the valve seat 46, the closure member 2 can be displaced from the intermediate position I into the closed position C.

In the closed position C the closure face 3 closes the opening 4 in a gas-tight manner and separates the first gas region 5 from the second gas region 6 in a gas-tight manner.

The vacuum valve 1 is thus opened and closed by means of the drive unit 8 as a result of an L-shaped movement of the closure member 2 and of the displacement arm 7. The shown transfer valve is therefore also referred to as an L-type valve.

In the open position O the first gas region 1 and the second gas region 6 are indeed connected to each other via the open opening 4 and form a common gas region, but these two gas regions 1 and 6 will be considered hereinafter as geometrical gas regions, the separation plane of which is determined by the closed position C. The separation plane between the first gas region 1 and the second gas region 6 is thus formed in the present case by the geometrical plane over which the valve seat 46 of the wall 47 extends, as shown in FIG. 1a.

The closure member 2 is mechanically fixed on the rear side 39 thereof, which is opposite the closure face 3, to the displacement arm 7 by means of a screw element 9a. The screw element is formed by a screw 9a, which is guided through a through-hole formed on the rear side 39 of the closure member 2 and engages in a thread of the displacement arm 7. This screw connection thus mechanically couples the closure member 2, which theoretically forms a first component part 10, to the displacement arm 7, which theoretically forms a second component part 11. Both component parts 10 and 11 are disposed within the first gas region 5, are component parts of the vacuum valve 1, and are mechanically coupled to the drive unit 8. In the present case the second component part 11, specifically the displacement arm 7, is directly mechanically coupled to the drive unit 8 and can be displaced thereby. Within the screw connection in the vicinity of the screw 9a, there is disposed a third gas region 27, which lies within the first gas region 5 and is fully enclosed thereby. The exact structure of this screw connection and the arrangement of the third gas region 27 will be described in greater detail hereinafter.

The vacuum valve in FIGS. 1a, 1b and 1c additionally has a second screw connection, by means of which the drive unit 8 is mechanically coupled to the wall 47. This screw connection is formed by screw 9a which is guided through a through-hole formed in the drive unit forming a theoretical first component part 10 and engages in a thread of the wall 47 forming a theoretical second component part 11, wherein a reverse arrangement is also possible. In this case the first component part 10, specifically the drive unit 8, is a component part of the vacuum valve 1, however the second component part 11, specifically the wall 47, does not itself necessarily have to be a component part of the vacuum valve 1, but can also be assigned to another unit, for example a vacuum chamber.

A second exemplary embodiment of the vacuum valve 1 similar to the first exemplary embodiment is illustrated in FIG. 2 in the closed position C. This second exemplary embodiment differs, however, from the first exemplary embodiment in that the screw 9a is guided through a through-hole formed in the displacement arm 7 and engages in a thread on the rear side 39 of the closure member 2. This screw connection thus mechanically couples the displacement arm 7, which theoretically forms a first component part 10, to the closure member 2, which theoretically forms a second component part 11. In the present case the first component part 10, specifically the displacement arm 7, is directly mechanically coupled to the drive unit 8 and can be displaced thereby. Within the screw connection in the vicinity of the screw 9a, there is disposed a third gas region 27, which lies within the first gas region 5 and is fully enclosed thereby. The exact structure of this screw connection and the arrangement of the third gas region 27 will also be described in greater detail hereinafter.

A closure member 2 and a displacement arm 7 with a crosspiece 40 are illustrated in FIGS. 3a and 3b in the form of a third embodiment. The crosspiece 40 extending transversely to the displacement axis 38 is connected at a middle connection point 41 to the displacement arm 7. This middle connection point 41 has a screw 9a, which is guided through a counterbore 28a and a through-hole 20 of the crosspiece 40 and engages in a thread in the displacement arm 7, said thread being formed in a blind hole 36. The crosspiece 40 thus theoretically forms a first component part 10, and the displacement arm 7 theoretically forms a second component part 11.

The crosspiece 40 is connected to the closure member 2 on the rear side 39 of the closure member 2, which is opposite the closure face 3, at two lateral connection points 42 arranged on both sides of the middle connection point 41. These lateral connection points 42 each have a screw 9a, which screws are each guided through a through-hole 20, which is formed in the crosspiece 40 and has a counterbore 28a, and engage in a thread in a blind hole 36, which thread is formed on the rear side 39 of the closure member 2. The crosspiece 40 thus theoretically forms a first component part 10 and the closure member 2 theoretically forms a second component part 11.

In a middle portion 43, which comprises the middle connection point 41 and portions adjoining said connection point on either side thereof and which extends between the lateral connection points 42, the crosspiece 40 has a distance 44 from the rear side 39, as shown in FIG. 3b. In other words, the crosspiece 40 is arranged in the middle portion 43 at a distance from the rear side 39 and does not contact the closure member 2 in this region. In other words, the crosspiece 40 spans the rear side 39 of the closure member 2 and rests on the rear side 39 of the closure member 2 exclusively in the region of the lateral connection points 42.

The crosspiece 40 formed in one piece from metal is resilient, in such a way that the closure member 2 can be pivoted, by means of a twisting of the crosspiece 40 relative to the displacement arm 7, about a pivot axis 45 arranged at right angles to the displacement axis 38 and extending parallel to the opening 4 and the valve seat 46, as illustrated in FIG. 3b.

The vacuum valve 1 additionally has two valve fastening holes 51 in the wall 47, by means of which the wall 47 coupled to the housing of the drive unit 8 can be mounted on a component, in particular on a vacuum chamber. This fastening can also be provided by means of a screw connection according to the invention, wherein the wall 47 having the valve fastening holes 51 theoretically forms the first component part 10 and the component forms the second component part 11.

A number of different screw connections are thus described in FIGS. 1a, 1b, 1c, 2, 3a and 3b, which differ from one another primarily in that the theoretical first component part 10 and the theoretical second component part 11 are each formed by different parts. In FIGS. 4a to 9b these component parts are therefore referred to theoretically as first component part 10 and as second component part 11, wherein these component parts can be formed by different parts, in particular of the vacuum valve 1. The different embodiments of these screw connections according to the invention will be described in detail hereinafter.

FIGS. 4a and 4b illustrate the first component part 10, in particular in the form of the closure member 2, the second component part 11, in particular in the form of the displacement arm 7, and the screw 9a.

The screw 9a is composed of a threaded portion 32 and a screw head 33 and has an engagement surface portion 15, a sealing surface portion 24, a force transfer surface portion 18, a threaded surface portion 12, and an end surface portion 50. The screw head 33 is a cylinder screw head.

The engagement surface portion 15, the force transfer surface portion 18, and the sealing surface portion 24 are arranged on the screw head 33.

A first thread 14a extending around a geometrical first axis 13 is formed on the threaded surface portion 12. The thread is a first external thread 14a.

An engagement 16 of this design in the manner of an internal hexagon is formed on the engagement surface portion 15, such that the screw 19a can be rotated about the first axis 13 by means of a tool 17 which can engage in a form-fitting manner in the engagement, specifically an external hexagon.

The force transfer surface portion 18 extending radially to the first axis 13 is arranged between the threaded surface portion 12 and the engagement surface portion 15 and points in a screw closing direction 19 extending along the first axis 13.

The first component part 10 has a cylindrical through-hole 20 extending along the first axis 13. A second thread in the form of a second internal thread 21a is formed in the second component part 11. This second thread 21a is formed in a blind hole 36 in the second component part 11.

As shown in FIG. 4a, the first component part 10 and the second component part 11 are mechanically coupled in a form-fitting manner by means of a threaded engagement, occurring through the through-hole 20, between the first external thread 14a of the first component part 10 and the second internal thread 21a of the second component part 11. The threaded surface portion 12 is arranged on the threaded portion 32 guided through the through-hole 20. The force transfer surface portion 18 rests here on a contact face 23 of the first component part 10. This contact face 23 extending radially to the first axis 13 surrounds the through-hole 20 and points in a screw opening direction 22, which is opposite the screw closing direction 19.

As is shown in FIG. 4a, the engagement surface portion 15 of the screw 9a is arranged in the first gas region 5.

The sealing surface portion 24, which encloses the first axis 13, is arranged between the force transfer surface portion 18 and the engagement surface portion 15 and separates this force transfer surface portion 18 and the engagement surface portion 15 from one another.

The screw head 33 of the screw 9a has an outer lateral surface 24 pointing outwardly and forming the sealing surface portion 24, which outer lateral surface has the geometrical shape of a geometrical straight circular cylinder lateral surface. The inner lateral surface 25 and the outer lateral surface 24 have the common geometrical first axis 13.

The end surface portion 50 is opposite the engagement surface portion 15 and points in the screw closing direction 19, wherein the threaded surface portion 12 is arranged between the end surface portion 50 and the force transfer surface portion 18.

A sealing face 25, which encloses the through-hole 20, is disposed adjacently to the contact face 23. The sealing face 25 is formed by an inner lateral surface pointing inwardly toward the first axis 13. This inner lateral surface 25 has a geometrical shape of the geometrical straight circular cylinder lateral surface formed by a cylindrical depression 28a in the first component part 10, which counterbore is arranged axially adjacently to the through-hole 20 and extends around the first axis 13. The base of this counterbore 28a forms the contact face 23.

A sealing seal element 26a is arranged between the sealing surface portion 24 of the screw 9a and the sealing face 25 of the first component 10. The seal element 26a is fixed on the sealing surface portion 24 of the screw 9a and is formed as an O-ring 26a. In order to fix this O-ring 26a, the sealing surface portion 24 has a peripheral groove 30. This O-ring 26a encloses the first axis 13 and is arranged in such a way that the first gas region 5 is separated from a third gas region 27, in which the threaded surface portion 12, the force transfer surface portion 18 and the end surface portion 50 are arranged, as shown in FIG. 4a.

A second seal element 35, which is formed as a second O-ring, seals against gas or particles, and is arranged sealingly between the first component part 10 and the second component part 11, separates the first gas region 5 and the third gas region 27 in a gas-tight or particle-tight manner, and encloses the through-hole 20.

This third gas region 27, in which the threaded surface portion 12, the force transfer surface portion 18 and the end surface portion 50 are arranged, is thus arranged within the first gas region 5 and is separated therefrom in a gas-tight or particle-tight manner by means of the O-ring 26a and the second O-ring 35 and is fully enclosed by the first gas region 5.

The seal element 26a and the second seal element 35 can be gas-tight, wherein the seal element 26a and the second seal element 35 are arranged in such a way that the first gas region 5 is separated in a gas-tight manner from the third gas region 27. A suitable seal material is elastomer, in particular rubber, in particular fluorinated rubber or perfluorinated rubber, for example. In the case of a gas-tight separation between the third gas region 27 and the first gas region 5, microparticles produced in the third gas region 27, in particular by friction at the contact points, are held in this third gas region 27 and cannot penetrate the first gas region 5, whereby the latter is kept free from any process-damaging microparticles.

Alternatively, at least one of the seal elements 26a or seals against particles in such a way that microparticles disposed in the third gas region 27 having a particle size of more than 1 or 0.1 or 0.01 micrometers are substantially blocked by the seal element 26a or 35 and are substantially prevented from infiltrating the first gas region 5. By way of example, the seal element 26a or 35 is formed as a filter, in particular as a HEPA filter, for filtering out particles having a particle size of more than 1 or 0.1 or 0.01 micrometers, in particular with a degree of separation of more than 85% or 95% or 99% or 99.5% or 99.95%. In particular, the seal element 26a or 35 consists of a fiber material or of a metallic material, in particular a sintered or woven metallic material.

In the fifth embodiment shown in FIGS. 5a and 5b, in contrast to the fourth embodiment, the seal element 26a is not fixed in a peripheral groove 30 on the sealing surface portion 24 of the screw 9a, but instead is held in the round countersink 28a on the sealing face 25 of the first component part 10. The seal element in the form of an O-ring 26a is held in a peripheral groove 31 of the sealing face 25 formed as a cylindrical inner lateral surface. The sealing surface portion 24 is in this case a smooth cylindrical outer lateral surface. An advantage of this embodiment lies in the fact that a conventional screw 9a, possibly having a machined cylindrical outer lateral surface, can be used.

In the case of the sixth exemplary embodiment illustrated in FIGS. 6a and 6b, the sealing surface portion 24 of the screw 9a is not disposed on the screw head 33, in contrast to the fourth and fifth embodiment, but instead is disposed on a thread-free cylindrical smooth part of the threaded portion 32. The sealing surface portion 24 is in this case a smooth cylindrical outer lateral surface on the threaded portion 32. In other words the sealing surface portion 24 lies between the threaded surface portion 12 and the force transfer surface portion 18. The seal element 26a does not lie in the round countersink 28a of the first component part 10, by contrast with the fifth embodiment, but instead lies in a portion of the through-hole 20 surrounding the smooth part of the threaded portion 32. The seal element in the form of an O-ring 26a is held within this portion of the through-hole 20 in a peripheral groove 31 of the sealing face 25 formed as a cylindrical inner lateral surface.

In the seventh exemplary embodiment, which is shown in FIGS. 7a and 7b, the screw 9a has an outer lateral surface pointing outwardly in part in the upper portion of the screw head 33 in the form of a bead and forming the sealing surface portion 24, which outer lateral surface has the geometrical shape of a geometrical straight circular cone lateral surface. The seal element 26a formed as an O-ring is fixed on the sealing face 25 in the round counterbore 28a of the first component 10, wherein the O-ring 26a is held in a peripheral groove 31 of the sealing face 25.

The screw 9a of the seventh exemplary embodiment has the threaded surface portion 12, on which the first thread extending around the geometrical first axis 13 is formed in the manner of the first external thread 14a. The engagement 16 of this design is formed on the engagement surface portion 15, such that the screw 9a can be rotated about the first axis 13 by means of the tool 17, which can engage in a form-fitting manner in the engagement. The force transfer surface portion 18 is arranged between the threaded surface portion 12 and the engagement surface portion 15 and points in the screw closing direction 19 extending along the first axis. The end surface portion 50 is opposite the engagement surface portion 15 and points in the screw closing direction 19. The threaded surface portion 12 is arranged between the end surface portion 50 and the force transfer surface portion 18. The screw 9a has the sealing surface portion 24, which is arranged between the threaded surface portion 12 and the engagement surface portion 15, separates the threaded surface portion 12 and the engagement surface portion 15 from one another, and surrounds the first axis 13.

A connection opening 48 in the form of a channel, in particular a cylindrical channel, extending along the first axis 13 is formed between the engagement surface portion 15 and the end surface portion 50. A filter element 49 is arranged in the connection opening 48. This filter element 49 is fixed in the engagement surface portion 15 and the engagement 16 at the end of the connection opening 48 on the screw head side.

The first gas region 5 and the third gas region 27 are connected to one another in a particle-tight, but gas-permeable manner by means of this connection opening 48 in the screw 9a, as shown in FIG. 7a.

The filter element 49 is designed to filter out particles having a particle size of more than 1 or 0.1 or 0.01 micrometers, in particular with a degree of separation of more than 85% or 95% or 99% or 99.5% or 99.95%, in particular in the form of a HEPA filter. By way of example, the filter element 49 consists of a fiber material or of a metallic material, in particular a sintered or woven metallic material.

A variant of the fourth embodiment shown in FIGS. 4a and 4b is illustrated in FIGS. 8a and 8b in the form of an eighth embodiment. The screw 9a has an outer lateral surface pointing outwardly and forming the sealing surface portion 24, which outer lateral surface has the geometrical shape of a geometrical straight circular cone lateral surface. The inner lateral surface 25 of the first component 10 also has the geometrical shape of a geometrical straight circular cone lateral surface and is formed by a countersink 28b in the first component part 10, which countersink is arranged axially adjacently to the through-hole 20 and extends around the first axis 13. The seal element is cured on, in the form of a gas-tight cured steel 26b, on the conical outer lateral surface 24 of the screw 9a.

The first gas region 5 and the third gas region 27 are connected to each other via a connection opening 52 formed in the first component part 10. This connection opening 52 extends radially to the through-hole 49, as shown in FIGS. 8a and 8b. A filter element 49 is arranged at the connection opening 52. As is also the case in the seventh embodiment, the filter element 49 seals against particles, in such a way that microparticles disposed in the third gas region 27 are substantially blocked by the filter element 49 and are substantially prevented from infiltrating the first gas region 5.

Whereas, in the previous embodiments, the screw element was always formed as a screw 9a, the screw element in the ninth embodiment in FIGS. 9a and 9b is formed by a nut 9b.

The second thread 21b of the second component part 11 is formed in this case on a threaded pin 34, which is guided through the through-hole 20 and which is assigned to the second component part 11.

The first thread of the screw element 9b is formed as a first internal thread 14b, and the second thread of the threaded pin 34 of the second component part 11 is formed as a second external thread 21b.

The first internal thread 14b is formed in a blind hole 37 in the nut 9b, wherein the nut is formed as a cap nut 9b, as illustrated in FIGS. 9a and 9b.

The first component part 10 has an inner lateral surface pointing inwardly toward the first axis 13 and forming the sealing face 25. This inner lateral surface 25 has the geometrical shape of a geometrical straight circular cylinder lateral surface, which is formed by a counterbore 28a in the first component part 10, which counterbore is arranged axially adjacently to the through-hole 20 and extends around the first axis 13.

The cap nut 9b has an outer lateral surface pointing outwardly and forming the sealing surface portion 24, which outer lateral surface has the geometrical shape of a geometrical straight circular cylinder lateral surface. The seal element 26a is fixed on the outer lateral surface 24 of the cap nut 9b. This seal element is formed as an O-ring 26a. The outer lateral surface 24 has a peripheral groove 30, in which the O-ring 26a is fixed.

The embodiments enable a drastic reduction of the number of microparticles in the first gas region, whereby the process reliability in vacuum applications for which the vacuum valves according to the invention are used can be significantly increased.

1. A vacuum valve having
a closure member, which has a closure face for the gas-tight closing of an opening connecting a first gas region to a second gas region,
a displacement arm, on which the closure member is arranged,
a drive unit, which is mechanically coupled to the displacement arm and which is designed in such a way that the closure member in the first gas region can be displaced back and forth, by displacement of the displacement arm by means of the drive unit, between
an open position, in which the closure member releases the opening, and
a closed position, in which the closure face closes the opening in a gas-tight manner and separates the first gas region from the second gas region in a gas-tight manner,
and
a screw element for connecting a first component part of the vacuum valve, which component part is arranged at least in part in the first gas region, to a second component part in a mechanically coupling manner, wherein the first component part or the second component part is mechanically coupled to the drive unit,
wherein
the screw element
has a threaded surface portion, on which a first thread extending about a geometric first axis is formed,
an engagement surface portion, on which an engagement of this design is formed, such that the screw element is rotatable and/or secured in a form-fitting manner against rotation about the first axis, in particular by means of a tool which can engage in a form-fitting manner in the engagement, and
a force transfer surface portion, which is arranged between the threaded surface portion and the engagement surface portion and which points at least in part in a screw closing direction extending along the first axis,
the first component part has a through-hole extending along the first axis,
the first component part and the second component part can be mechanically coupled in a form-fitting manner by
a threaded engagement, carried out through the through-hole, between the first thread of the screw element and a second thread assigned to the second component part, and by
resting the force transfer surface portion on a contact face of the first component part surrounding the through-hole and pointing at least in part in a screw opening direction, which is opposite the screw closing direction,
the engagement surface portion of the screw element is arranged in the first gas region,
wherein,
the screw element has a sealing surface portion,
which is arranged between the threaded surface portion and the engagement surface portion, and
which separates the threaded surface portion and the engagement surface portion from one another, and
which encloses the first axis,
the first component part has, adjacently to the contact face, a sealing face enclosing the through-hole and
a sealing seal element, enclosing the first axis, is arranged between the sealing surface portion of the screw element and the sealing face of the first component part in such a way that the first gas region is separated from a third gas region, in which the threaded surface portion is arranged.

2. The vacuum valve as claimed in claim 1,
wherein,
the sealing surface portion is arranged between the force transfer surface portion and the engagement surface portion in such a way that the force transfer surface portion is in the third gas region.

3. The vacuum valve as claimed in claim 1,
wherein,
the first component part has an inner lateral surface pointing at least in part inwardly toward the first axis and forming the sealing face,
the screw element has an outer lateral surface pointing at least in part outwardly and forming the sealing surface portion, which outer lateral surface has in particular the geometrical shape of a geometrical straight circular cylinder lateral surface or a geometrical straight circular cone lateral surface, and
the inner lateral surface and the outer lateral surface have in particular the common geometrical first axis.

4. The vacuum valve as claimed in claim 3,
wherein,
the inner lateral surface has the geometrical shape
of a geometrical straight circular cylinder lateral surface, which is formed in particular by a counterbore in the first component part, which counterbore is arranged axially adjacently to the through-hole and extends around the first axis, or
of a geometrical straight circular cone lateral surface, which is formed in particular by a countersink in the first component part, which countersink is arranged axially adjacently to the through-hole and extends around the first axis.

5. The vacuum valve as claimed in claim 1,
wherein,
the seal element is fixed on the sealing surface portion of the screw element, in particular wherein
the seal element is formed as an O-ring and the sealing surface portion has a peripheral groove, in which the O-ring is fixed, or
the seal element is formed as a cured-on seal and is cured on, on the sealing surface portion.

6. The vacuum valve as claimed in claim 1, wherein,
the seal element is fixed on the sealing face of the first component part, in particular wherein
the seal element is formed as an O-ring and the sealing face has a peripheral groove, in which the O-ring is fixed, or
the seal element is formed as a cured-on seal and is cured on, on the sealing face.

7. The vacuum valve as claimed in claim 1, wherein,
the seal element
is gas-tight and
is arranged between the sealing surface portion and the sealing face in such a way that the first gas region is separated from the third gas region in a gas-tight manner,
in particular wherein the seal element consists substantially of an elastomer,
in particular rubber, in particular fluorinated rubber or perfluorinated rubber.

8. The vacuum valve as claimed in claim 1, wherein,
the seal element
seals against particles, in such a way that microparticles disposed in the third gas region having a particle size of more than 1 or 0.1 or 0.01 micrometers are substantially blocked by the seal element and are substantially prevented from infiltrating the first gas region,
in particular the seal element is formed as a filter, in particular as a HEPA filter, for filtering out particles having a particle size of more than 1 or 0.1 or 0.01 micrometers, in particular with a degree of separation of more than 85% or 95% or 99% or 99.5% or 99.95%,
in particular the seal element consists of a fiber material or a metallic material, in particular a sintered or a woven metallic material.

9. The vacuum valve as claimed in claim 1, wherein,
the first gas region and the third gas region are connected to each other via a connection opening and
a filter element is arranged in or at the first connection opening,
the filter element seals against particles, in such a way that microparticles disposed in the third gas region of more than 1 or 0.1 or 0.01 micrometers are substantially blocked by the filter element and are substantially prevented from infiltrating the first gas region,
in particular the filter element is designed to filter out particles of more than 1 or 0.1 or 0.01 micrometers, in particular with a degree of separation of more than 85% or 95% or 99% or 99.5% or 99.95%, in particular in the form of a HEPA filter,
in particular the filter element consists of a fiber material or a metallic material, in particular a sintered or a woven metallic material.

10. The vacuum valve as claimed in claim 9,
wherein, the connection opening and the filter element are arranged in the screw element.

11. The vacuum valve as claimed in claim 1, wherein,
the screw element is formed as a screw having a threaded portion and a screw head,
the threaded surface portion is arranged on the threaded portion guided through the through-hole,
the engagement surface portion, the force transfer surface portion and the sealing surface portion are arranged on the screw head,
in particular the first thread is formed as a first external thread and the second thread is formed as a second internal thread,
in particular the second thread is formed in a blind hole in the second component part and
in particular the screw head is formed as a cylinder screw head.

12. The vacuum valve as claimed in claim 1, wherein,
the screw element is formed as a nut,
the second thread is formed on a threaded pin of the second component part guided through the through-hole,
in particular the first thread is formed as a first internal thread and the second thread is formed as a second external thread,
in particular the first thread is formed in a blind hole in the nut, and
in particular the nut is formed as a cap nut.

13. The vacuum valve as claimed in claim 1, wherein,
the third gas region, in which the threaded surface portion is arranged,
is arranged within the first gas region and is separated therefrom in particular in a gas-tight or particle-tight manner, and
is completely enclosed by the first gas region.

14. The vacuum valve as claimed in claim 1, further comprising:
a second seal element formed in particular as a second O-ring and sealing against gas or particles,
which seal element is arranged sealingly between the first component part and the second component part,
separate the first gas region and the third gas region in a gas-tight or particle-tight manner, and
in particular encloses the through-hole.

15. The vacuum valve as claimed in claim 1, wherein,
the closure member is planar and the vacuum valve is formed in particular as a transfer valve,
the displacement arm is rod-shaped and extends along a geometrical displacement axis, and
the drive unit is formed in such a way that the closure member can be displaced, by displacing the displacement arm in an axial direction parallel to the displacement axis by means of the drive unit, between
the open position and
an intermediate position, in which the closure face covers the opening and is disposed opposite and at a distance from a valve seat surrounding the opening,
and can be displaced, in a direction transverse to the displacement axis, between
the intermediate position and
the closed position.

16. The vacuum valve as claimed in claim 1, wherein,
the first component part is formed by the displacement arm and
the second component part is formed by the closure member
or
the first component part is formed by the closure member and
the second component part is formed by the displacement arm
and
the displacement arm and the closure member are connected by means of the screw element.

17. The vacuum valve as claimed in claim 15,
wherein,
a crosspiece extending transversely to the displacement axis is connected at a middle connection point to the displacement arm,
the crosspiece
is connected to the closure member, on a rear side of the closure member opposite the closure face, at least at two lateral connection points disposed on both sides of the middle connection point,
is arranged at a distance from the rear side in a middle portion, which comprises the middle connection point and portions adjoining the middle connection point on both sides and which extends between the lateral connection points,
is resilient, such that, by twisting the crosspiece, the closure member can be pivoted relative to the displacement arm about a pivot axis arranged at right angles to the displacement axis, and
in particular is formed in one piece, and
the middle connection point comprises the screw element, and the first component part is formed by the displacement arm and the second component part is formed by the crosspiece, or the first component part is formed by the crosspiece and the second component part is formed by the displacement arm
and/or
the lateral connection points each comprise a screw element, and the first component part is formed by the closure member and the second component part is formed by the crosspiece, or the first component part is formed by the crosspiece and the second component part is formed by the closure member.

18. The vacuum valve as claimed in claim 1, wherein,
the first component part is formed by the drive unit and the second component part is formed by a wall comprising the opening, or
the first component part is formed by a wall comprising the opening, and the second component part is formed by the drive unit.

19. A screw element, in particular a screw or nut for a vacuum valve as claimed in claim 1, having
a threaded surface portion, on which a first thread extending around a geometric first axis is formed,
an engagement surface portion, on which an engagement of this design is formed, such that the screw element is rotatable and/or secured in a form-fitting manner against rotation about the first axis, in particular by means of a tool which can engage in a form-fitting manner in the engagement,
a force transfer surface portion, which is arranged between the threaded surface portion and the engagement surface portion and which points at least in part in a screw closing direction extending along the first axis,
an end surface portion, which is opposite the engagement surface portion and which points at least in part in the screw closing direction, wherein the threaded surface portion is arranged between the end surface portion and the fourth transfer surface portion,
wherein,
the screw element has a sealing surface portion,
which is arranged between the threaded surface portion and the engagement surface portion, and
which separates the threaded surface portion and the engagement surface portion from one another, and
which encloses the first axis,
a seal element is fixed on the sealing surface portion of the screw element, in particular wherein
the seal element consists substantially of an elastomer, in particular rubber, in particular fluorinated rubber or perfluorinated rubber,
and/or
the seal element is formed as an O-ring and the sealing surface portion comprises a peripheral groove, in which the O-ring is fixed, or
the seal element is formed as a cured-on seal and is cured on, on the sealing surface portion,
a connection opening is formed between the engagement surface portion and the end surface portion,
a filter element is arranged in the connection opening,
in particular the filter element is designed to filter out particles of more than 1 or 0.1 or 0.01 micrometers, in particular with a degree of separation of more than 85% or 95% or 99% or 99.5% or 99.95%, in particular in the form of a HEPA filter,
in particular the filter element consists of a fiber material or a metallic material, in particular a sintered or a woven metallic material, and
in particular the screw element has an outer lateral surface, pointing at least in part outwardly and forming the sealing surface portion, which outer lateral surface in particular has the geometrical shape
of a geometrical straight circular cylinder lateral surface
or
of a geometrical straight circular cone lateral surface.
